(19) United States
(12) Patent Application Publication
(10) Pub. No.: US 2015/0171738 A1
(43) Pub. Date: Jun. 18, 2015

(54) SEMICONDUCTOR DEVICE

(71) Applicant: FUJITSU LIMITED, Kawasaki-shi (JP)

(72) Inventors: Satoshi TANABE, Kawasaki (JP); Kenichi Kawasaki, Kawasaki (JP)

(21) Appl. No.: 14/569,335

(22) Filed: Dec. 12, 2014

(30) Foreign Application Priority Data
Dec. 18, 2013 (JP) 2013-261158

(51) Int. Cl. H02M 1/32; H02M 3/156

(52) U.S. Cl. CPC H02M 1/32; H02M 3/156

(57) ABSTRACT

A semiconductor device includes: first-power-supply that supplies first-power-supply-voltage; second-power-supply that supplies second-power-supply-voltage that is equal to or higher than the first-power-supply-voltage; first-circuit-block that is supplied with the first-power-supply-voltage from the first-power-supply to operate; second-circuit-block that is supplied with the second-power-supply-voltage from the second-power-supply to operate; level-shifters that are supplied with the first-power-supply-voltage and the second-power-supply-voltage from the first-power-supply and the second-power-supply to operate and shift a signal for the first-power-supply-voltage to a signal for the second-power-supply-voltage and shift the signal for the second-power-supply-voltage to the signal for the first-power-supply-voltage; a power-management-unit that controls the first-power-supply to change the first-power-supply-voltage; and a level-shifter-monitor-circuit that generates first-malfunction-signal at a first-margin-voltage that is higher than the first-power-supply-voltage at which the level-shifter does not normally operate in a case where the first-power-supply-voltage lowers, wherein the power-management-unit controls the first-power-supply so that the first-power-supply-voltage does not become lower than the first-margin-voltage.

### CROSS-REFERENCE TO RELATED APPLICATION

This application is based upon and claims the benefit of priority of the prior Japanese Patent Application No. 2013-261158, filed on Dec. 18, 2013, the entire contents of which are incorporated herein by reference.

### FIELD

The embodiments discussed herein are related to a semiconductor device.

### BACKGROUND

In recent years, reduced power consumption of a semiconductor device (LSI) has been further strongly demanded. Accordingly, power consumption is reduced by lowering an operating frequency in a case where a load decreases. Further, it is desired that power consumption is reduced with satisfaction of demanded performance in spite of manufacturing variability, temperature change, and so forth.

For example, in a case where a threshold value (Vth) of a transistor increases due to the manufacturing variability, an operation rate of the transistor becomes slow, and a signal propagation delay of a circuit increases. Thus, it is desired that a high power supply voltage VDD is set to decrease the delay so that a demanded operating frequency is satisfied.

On the other hand, in a case where the threshold value (Vth) of the transistor decreases due to the manufacturing variability, the operation rate of the transistor becomes fast, and a leakage current amount of the circuit increases, resulting in an increase in energy consumption. Thus, it is desired that a low power supply voltage VDD is set to reduce the energy consumption of the circuit to a limit in which the demanded operating frequency is satisfied in spite of the delay.

Accordingly, a power supply voltage is controlled in accordance with the operating frequency, the manufacturing variability, and the temperature change, and energy consumption per performance is thereby reduced while demanded performance is satisfied. This is referred to as an adaptive voltage scaling (AVS) power management technology.

There are cases where the AVS power management technology is applied to the entire circuit of the semiconductor device and where the semiconductor device is divided into a plurality of circuit blocks and control of power supplies to the circuit blocks is performed while including distribution of loads to the circuit blocks. In order to control the power supplies to the circuit blocks, independent power supplies are provided for the circuit blocks, and at least one of the circuit blocks individually controls the power supply voltage. This will be referred to as multiple power supply AVS management technology. In such a case, a state occurs where the power supply voltages are different between the circuit blocks. Thus, in a case where signals are interchanged between the circuit blocks (interfacing), the interchange of signals is performed via a level shifter that shifts a level of a signal.

The multiple power supply AVS management technology in this application has a circuit configuration in which circuit areas that are respectively connected to at least two power supply lines (VDD1 and VDD2) are provided, the AVS management technology is applied to at least one of the areas, and signals are interchanged between the areas via the level shifter. For example, an example of a multiple power supply configuration is disclosed in David Bol, et al., “A 25 MHz 7 μW/MHz Ultra-Low-Voltage Microcontroller SoC in 65 nm LP/GP CMOS for Low-Carbon Wireless Sensor Nodes”, ISSCC, 2012.

In a case where the AVS management technology is applied to the circuit blocks, the power supply voltages are lowered as much as possible in a range in which the circuit blocks normally operate. In general, the delay of the circuit is measured by providing a delay monitor circuit that has a ring oscillator and a counter and measuring a change in a frequency of the ring oscillator that changes in accordance with the power supply voltage by counting a change in an output signal. Then, a determination is made whether or not a count value is smaller than the delay with which the demanded operating frequency is satisfied.

Examples of related art are Japanese Laid-open Patent Publications Nos. 2004-165732, 2005-102086, and 2005-301083.

However, in a case where the semiconductor device is divided into a plurality of circuit blocks and the multiple power supply AVS management technology is applied thereto and the threshold value Vth of the transistor of a first circuit block is offset to the fast side, the power supply voltage VDD1 of the first circuit block is lowered by the AVS management technology. On the other hand, in a case where the power supply voltage VDD2 of a second circuit block to which signals are supplied from the first circuit block via the level shifter is maintained at a high voltage, a difference occurs between the power supply voltage VDD1 of the first circuit block and the power supply voltage VDD2 of the second circuit block. In a case where the difference becomes large, the level shifter stops operating, and the voltage of a signal of the power supply voltage VDD1 may not be increased to the voltage of a signal of the power supply voltage VDD2.

In a case of applying the AVS management technology, the power supply voltage is not lowered to a voltage at which failure of a circuit operation (malfunction) occurs but set to a voltage that is slightly higher than the power supply voltage that is close to malfunction.

The above delay monitor circuit may not in advance detect malfunction of the level shifter and has difficulty in controlling the power supply voltage to the power supply voltage that is slightly higher than the voltage at which the malfunction occurs.

### SUMMARY

According to an aspect of the invention, a semiconductor device includes: first-power-supply that supplies first-power-supply-voltage; second-power-supply that supplies second-power-supply-voltage that is equal to or higher than the first-power-supply-voltage; first-circuit-block that is supplied with the first-power-supply-voltage from the first-power-supply to operate; second-circuit-block that is supplied with the second-power-supply-voltage from the second-power-supply to operate; level-shifters that are supplied with the first-power-supply-voltage and the second-power-supply-voltage from the first-power-supply and the second-power-supply to operate and shift a signal for the first-power-supply-voltage to a signal for the second-power-supply-voltage and shift the signal for the second-power-supply-voltage to the signal for the first-power-supply-voltage; a power-management-unit that controls the first-power-supply to change the first-power-supply-voltage; and a level-shifter-monitor-circuit that generates first-malfunction-signal at a first-margin-voltage that is higher than the first-power-supply-voltage at which the level-shifter does not normally operate in a case where the first-power-supply-voltage lowers, wherein the power-management-unit controls the first-power-supply so that the first-power-supply-voltage does not become lower than the first-margin-voltage.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a schematic configuration of a semiconductor device in which an AVS technology is applied to a single power supply that supplies a power supply voltage to an entire circuit;

FIG. 2 explains control of the single power supply illustrated in FIG. 1 in the AVS technology;

FIG. 3 illustrates a schematic configuration of a semiconductor device to which a multiple power supply AVS technology is applied in a case where the semiconductor device has a plurality of circuit blocks and has a plurality of power supplies that supply power supply voltages to the plurality of respective circuit blocks;

FIG. 4 is an operation state transition diagram that illustrates an operation sequence of the semiconductor device to which a multiple power supply AVS technology of FIG. 3 is applied;

FIG. 5 is a timing diagram that illustrates an operation of the semiconductor device to which the multiple power supply AVS technology of FIG. 3 is applied;

FIGS. 6A and 6B explain a problem in a case where a VDD1 is largely lowered, in which FIG. 6A illustrates a circuit configuration and FIG. 6B explains a problem with control in the AVS technology;

FIG. 7 is a timing diagram in a case where an operation rate of a transistor is fast in the semiconductor device to which the multiple power supply AVS technology described in FIG. 6A is applied and the semiconductor device operates without restricting the VDD1 to a VDDmin or higher;

FIG. 8 illustrates a circuit configuration of a semiconductor device of a first embodiment;

FIG. 9 explains control in the AVS technology that is executed in the first embodiment;

FIG. 10 is a block diagram that illustrates a configuration example of a level shifter monitor circuit;

FIG. 11 is a circuit diagram that illustrates a more specific configuration example of the level shifter monitor circuit;

FIGS. 12A and 12B illustrate configuration examples of a malfunction circuit;

FIG. 13 illustrates a result of an operation simulation of the level shifter monitor circuit of FIG. 11;

FIG. 14 is an operation state transition diagram that illustrates an operation sequence of the semiconductor device to which the multiple power supply AVS technology of the first embodiment is applied;

FIG. 15 is a block diagram that illustrates a circuit configuration of a power management unit (PMU);

FIG. 16 is a timing diagram that illustrates an operation of the PMU;

FIG. 17 illustrates a circuit configuration of a level shifter monitor circuit of a semiconductor device of a second embodiment;

FIG. 18 is an operation state transition diagram that illustrates an operation sequence of the semiconductor device to which the multiple power supply AVS technology of the second embodiment is applied;

FIG. 19 is a block diagram that illustrates a circuit configuration of a power management unit (PMU) of the semiconductor device of the second embodiment;

FIG. 20 is a timing diagram that illustrates an operation of the PMU of the second embodiment; and

FIG. 21 is a timing diagram that illustrates the operation of the PMU of the second embodiment.

### DESCRIPTION OF EMBODIMENTS

A common power management technology will be described before embodiments are described.

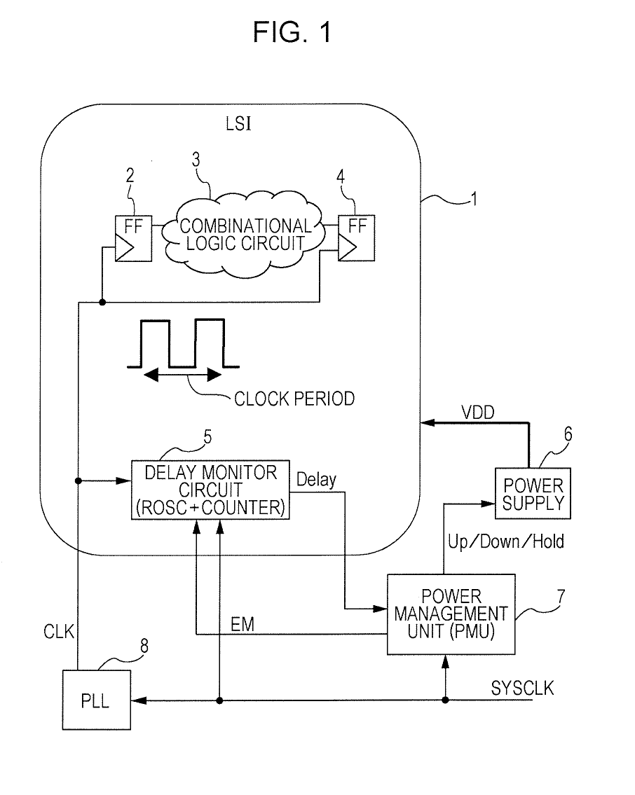

FIG. 1 illustrates a schematic configuration of a semiconductor device in which an AVS technology is applied to a single power supply that supplies a power supply voltage to an entire circuit.

The semiconductor device has a circuit block 1, a power supply 6, a power management unit (PMU) 7, and a phase locked loop (PLL) 8. Although there is a configuration in which the power supply 6, the PMU 7, and the PLL 8 are provided outside an LSI and only the circuit block 1 is provided in the LSI, configurations that include such a case are also referred to as the semiconductor device.

The power supply 6 supplies a power supply voltage VDD to the circuit block 1 and so forth (including the PMU 7 and the PLL 8). The power supply 6 changes the power supply voltage VDD in accordance with a command from the PMU 7. The PMU 7 receives a system clock SYSCLK that is externally supplied (or separately generated internally), receives information about a delay from the delay monitor circuit 5 that will be described later, and outputs a power management signal (Up, Down, or Hold) to control the power supply voltage VDD that is output by the power supply 6. The PMU 7 further controls an operation state of the delay monitor circuit 5. Although not illustrated, the PMU 7 receives information about a load state of the semiconductor device in some manner and controls the power supply 6 in accordance with the information. The PLL 8 generates an internal clock CLK from the system clock SYSCLK and supplies the internal clock CLK to the circuit block 1. Although not illustrated, the PLL 8 receives a command about a frequency of the internal clock CLK in some manner (for example, from the PMU 7) and generates the internal clock CLK of a frequency of the command.

The circuit block 1 has a large number of circuit elements that include a flip-flop (FF) 2, a combinational logic circuit 3, and an FF 4. The FF 2 synchronously operates with the internal clock CLK that is supplied from the PLL 8, and outputs a signal from another circuit portion or from the outside to the combinational logic circuit 3 synchronously with the internal clock CLK. The combinational logic circuit 3 receives signals from the FF 2 and an FF that is not illustrated, performs a logical operation, and outputs the signals to the FF 4. The FF 4 synchronously operates with the internal clock CLK, and outputs a signal from the combinational logic circuit 3 to another circuit portion or the outside synchronously with the CLK.

The circuit block 1 is formed with a ring oscillator and a counter and has the delay monitor circuit 5 that receives the system clock SYSCLK and the internal clock CLK and generates a delay of the circuit in a case where an operation is performed at the power supply voltage VDD. An examination for a delay of a circuit (transistor) with which the circuit block 1 does not malfunction and normally operates is in advance performed, and a delay of the delay monitor circuit 5 that corresponds to the delay is set. An operation state (On or Off) of the delay monitor circuit 5 is controlled in accordance with a control signal EN from the PMU 7.

The PMU 7 receives the information about the load state of the semiconductor device and controls the power supply 6 so that the power supply voltage VDD lowers as much as possible in a range in which delay information of the delay monitor circuit 5 satisfies a preset condition.

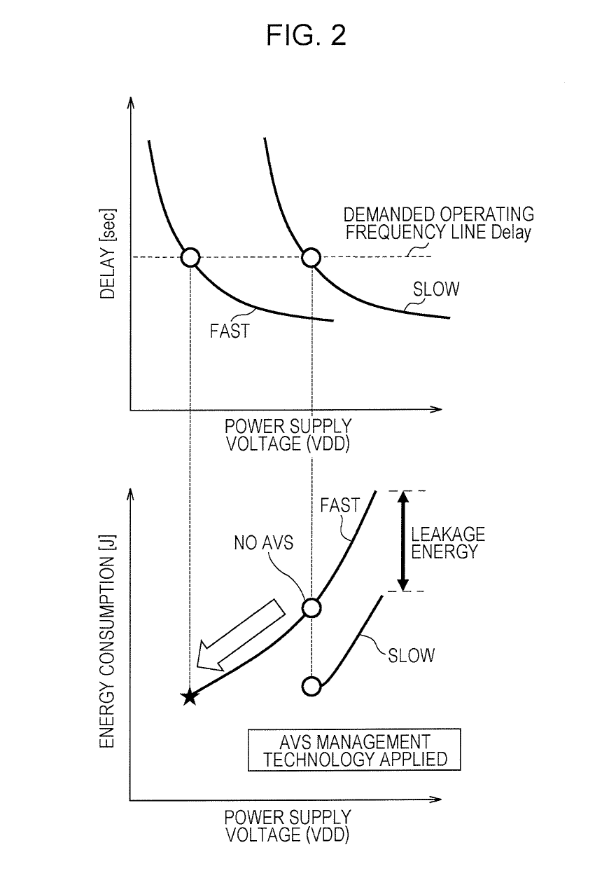

FIG. 2 explains control of a single power supply illustrated in FIG. 1 in the AVS technology. An upper side of FIG. 2 illustrates a change in a delay of the circuit (transistor) with respect to a change in the power supply voltage VDD and illustrates cases where operation rates of the transistor are slow and fast. A lower side of FIG. 2 illustrates an example of a change in circuit energy consumption with respect to the change in the power supply voltage VDD and illustrates the cases where the operation rates of the transistor are slow and fast. Illustrated curves change also in accordance with a temperature condition.

On the upper side of FIG. 2, the circuit normally operates in a case where the delay is lower than a demanded operating frequency line Delay and malfunctions in a case where the delay is higher than the line. As illustrated, the delay lowers as the power supply voltage VDD lowers. However, the power supply voltage VDD that realizes the demanded operating frequency of the circuit differs between the case where the operation rate of the transistor is slow and the case where the operation rate of the transistor is fast.

In a case where the AVS technology is not applied, in consideration of manufacturing variability, the power supply voltage VDD is set high so that the delay becomes necessarily lower than the demanded operating frequency line Delay even in a case where the operation rate of the transistor is slow. Thus, as illustrated in the lower side of FIG. 2, in a case where a transistor whose operation rate is fast is manufactured, the energy consumption increases because the power supply voltage VDD is set high and a leakage current amount of the circuit increases. In other words, the high power supply voltage VDD is set despite the fact that the energy consumption may be reduced by further lowering the power supply voltage VDD.

As illustrated in the lower side of FIG. 2, in a case where the AVS technology is applied, the delay of an actually manufactured transistor is measured by the delay monitor circuit 5, and the energy consumption is reduced by further lowering the power supply voltage VDD to a limit in a case where the operation rate of the transistor is fast.

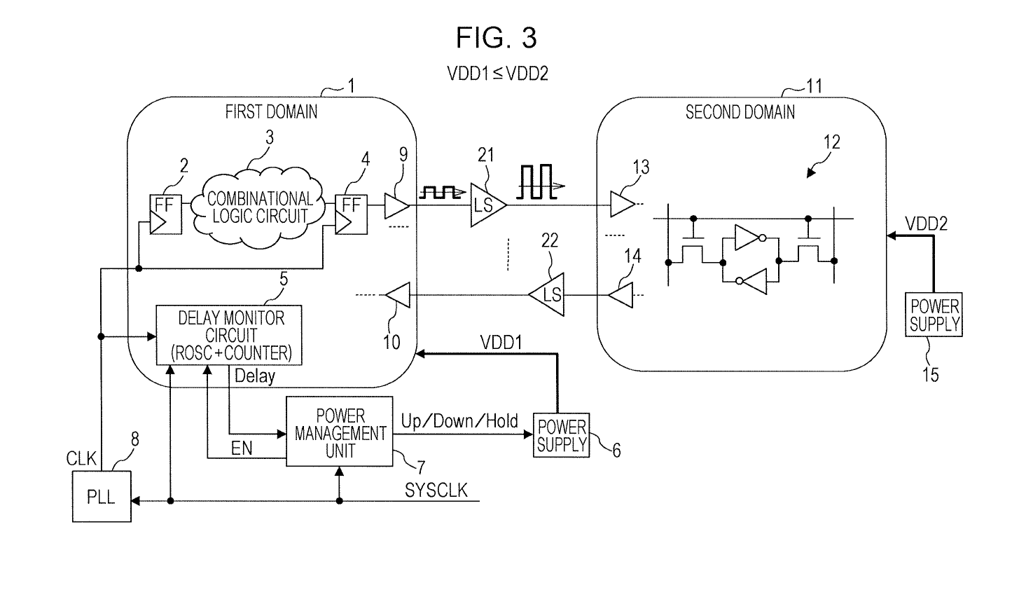

FIG. 3 illustrates a schematic configuration of a semiconductor device to which a multiple power supply AVS technology is applied in a case where the semiconductor device has a plurality of circuit blocks and has a plurality of power supplies that supply power supply voltages to the plurality of respective circuit blocks.

The semiconductor device has a first circuit block 1, a power supply 6 for the first circuit block, a PMU 7 for the first circuit block, a PLL 8 for the first circuit block, a second circuit block 11, a power supply 15 for the second circuit block, and level shifters (LS) 21 and 22.

The first circuit block (first domain) 1. has the FF 2, the combinational logic circuit 3, the FF 4, and the delay monitor circuit 5, similarly to FIG. 1, and an output buffer 9 and an input buffer 10. In other words, the first circuit block 1 has the same configuration as FIG. 1 except having the output buffer 9 and the input buffer 10. The power supply 6, the PMU 7, and the PLL 8 are in the same configuration as FIG. 1.

The second circuit block (second domain) 11 is illustrated as an SRAM as an example and has a large number of SRAM elements 12, peripheral circuits thereof, an input buffer 13, and an output buffer 14. The power supply 15 for the second circuit block supplies a power supply voltage VDD2 to the second domain 11. Because data stored in the SRAM may be destroyed when the power supply voltage is lowered, it is assumed here that the power supply voltage VDD2 is fixed. Thus, the power supply 15 has a fixed output voltage, and the PMU is not provided for the second domain 11.

The level shifter 21 shifts the level of signals from the first domain 1 and outputs the signals to the second domain 11. The level shifter 22 shifts the level of signals from the second domain 11 and outputs the signals to the first domain 1. Here, because the AVS technology is applied to only the first domain 1 and not applied to the second domain 11, it is assumed that VDD1≦VDD2.

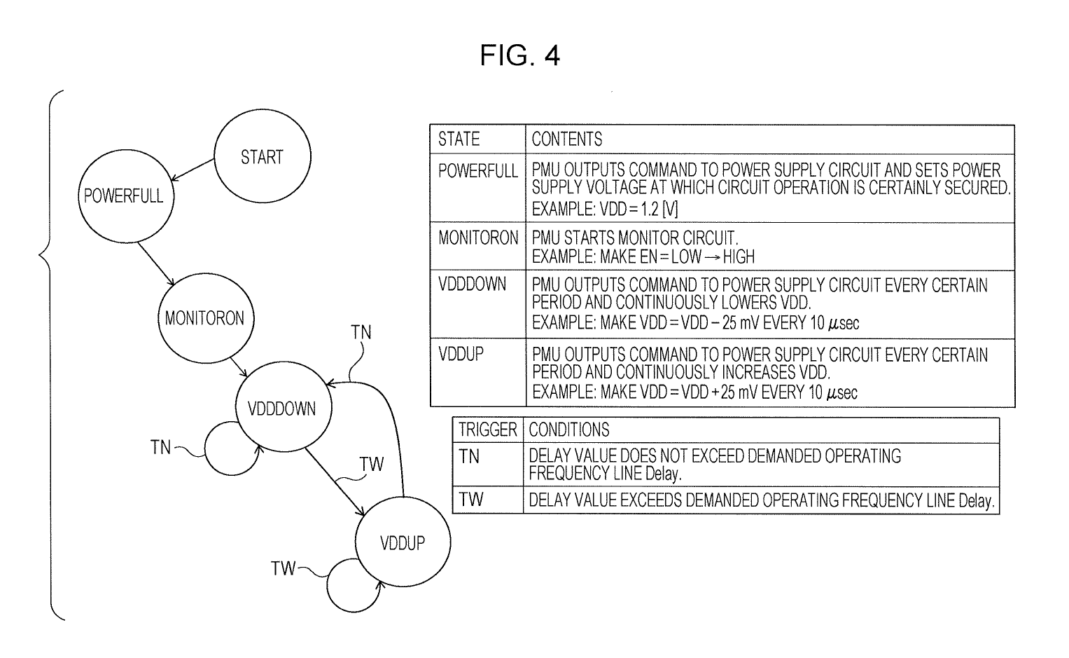

FIG. 4 is an operation state transition diagram that illustrates an operation sequence of the semiconductor device to which a multiple power supply AVS technology of FIG. 3 is applied. This transition diagram relates only to the first domain 1.

As illustrated in FIG. 4, the operation sequence starts from “START” and transits among the states of “POWERFULL”, “MONITORON”, “VDDDOWN”, and “VDDUP”. Descriptions of the states and triggers of transition in the states of “VDDDOWN” and “VDDUP” are indicated in a chart of FIG. 4, and descriptions thereof will not be made.

In the AVS technology, the VDD1 is lowered when the delay of the first domain 1 is smaller than a limit, and the VDD1 is increased when the delay of the first domain 1 becomes greater than the limit.

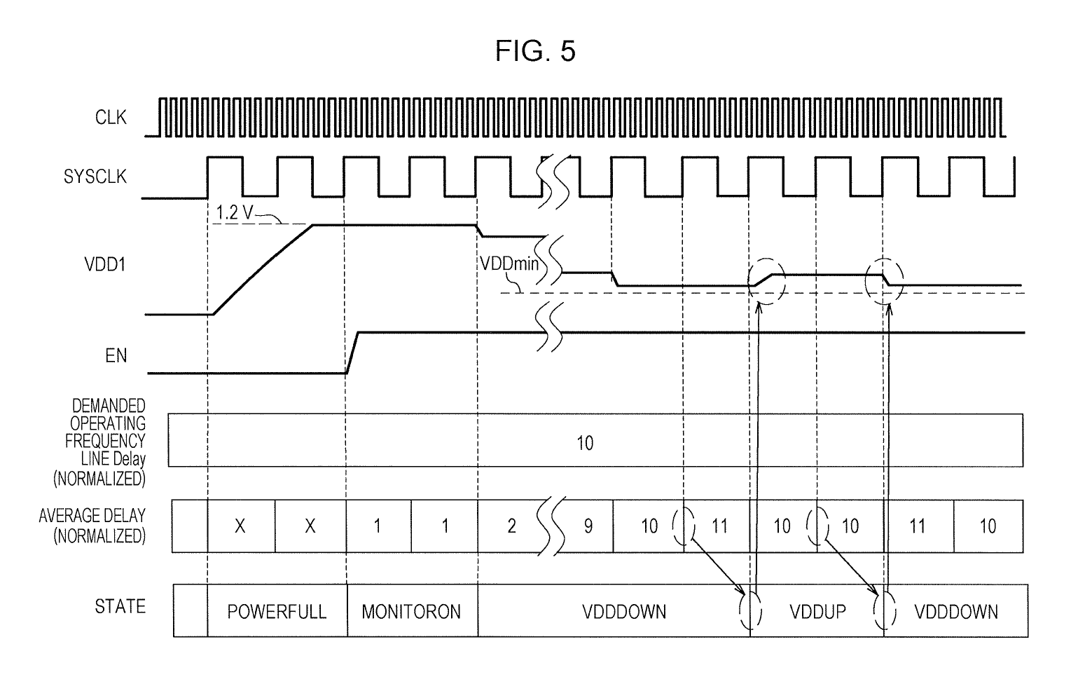

FIG. 5 is a timing diagram that illustrates an operation of the semiconductor device to which the multiple power supply AVS technology of FIG. 3 is applied. This timing diagram relates only to the first domain 1.

The operation starts from “START”, and the VDD1 increases in “POWERFULL” and increases to a maximum value of 1.2 V, for example.

The PMU 7 turns the EN that is output to the delay monitor circuit 5 on (high) in “MONITORON”. In response to this, the delay monitor circuit 5 measures and outputs the delay. Here, it is assumed that the delay of a limit line of the demanded operating frequency is “10”. The VDD1 is the maximum value, the delay is thus small, and “1” is output, for example.

Because the delay is lower than the limit line, the state transits to “VDDDOWN”, and the VDD1 is lowered by a unit amount. Repeating this leads to a stepwise increase of the delay, and the delay of the limit line increases (to “11”) exceeding “10”. In response to this, the state transits to “VDDUP”, and the VDD1 is increased by the unit amount. Because the VDD1 increases, the delay again becomes “10”, and the state transits to “VDDDOWN”. Such an operation is repeated subsequently. Accordingly, the VDD1 is controlled so that the delay is around the limit line.

The circuit block (first domain) 1 actually does not normally operate in a case where the delay that is output by the delay monitor circuit 5 is “12”, for example. In such a case, the delay of the limit line of the demanded operation frequency is set to “10”. Accordingly, malfunction does not occur during the operation.

Here, in a case where the threshold value Vth of the transistor of the first circuit block (first domain) 1 is largely offset to the fast side, the VDD1 may largely be lowered by the AVS management technology.

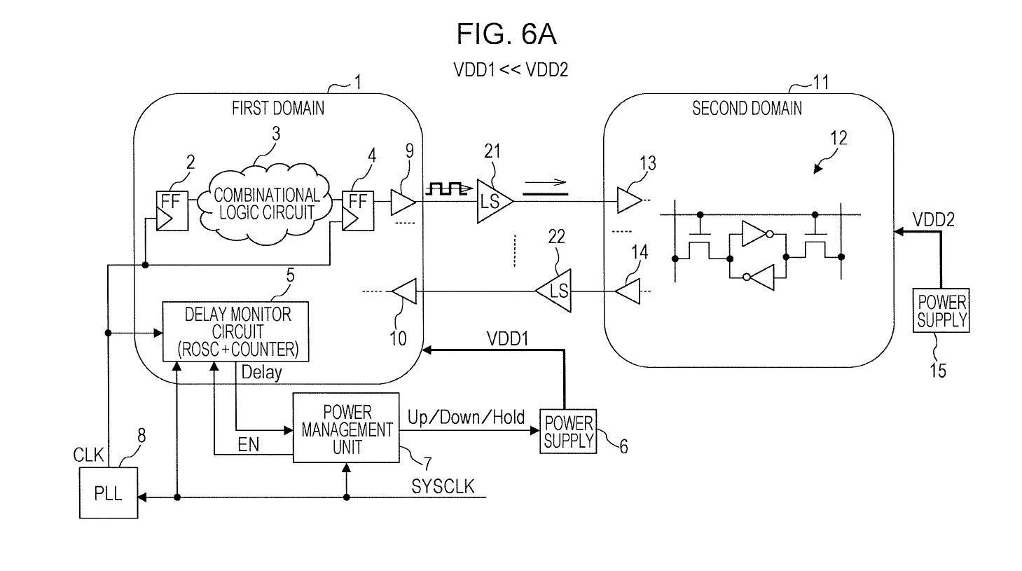

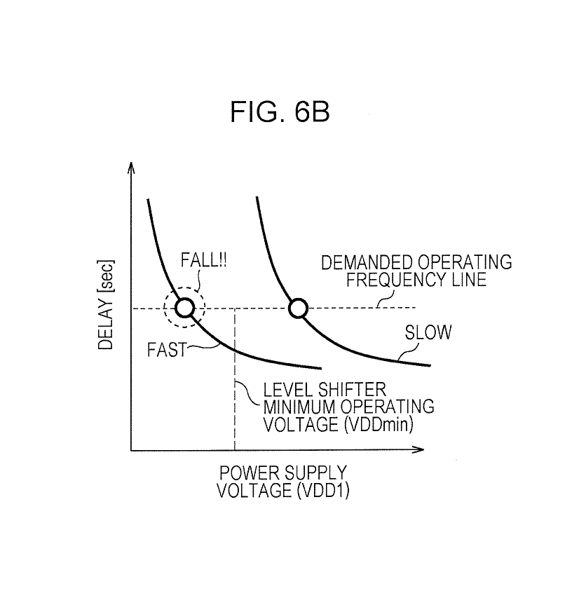

FIGS. 6A and 6B explain a problem in a case where the VDD1 is largely lowered, in which FIG. 6A illustrates a circuit configuration and FIG. 6B explains a problem with control in the AVS technology.

As described above, in a case where the VDD1 is lowered by application of the AVS management technology, the VDD1 is lowered in a range in which the first domain 1 normally operates, and thus the first domain 1 normally operates. However, in a case where a difference between the VDD1 and the VDD2 becomes large, a problem occurs that the level shifters 21 and 22, particularly the level shifter 21 that shifts the level of the signals of the VDD1 to the level of the signals of the VDD2 stops operating.

The level shifters (LS) respectively receive the VDD1 and the VDD2 and shift the signals for the VDD1 into the signals for the VDD2 and shift the signals for the VDD2 into the signals for the VDD1. For example, the level shifter 21 shifts the signals for the VDD1 to the high level of the signals for the VDD2 in a case where the signals of the VDD1 are higher than a threshold value of a determination circuit for the VDD2 and shifts the signals for the VDD1 to the low level of the signals for the VDD2 in a case where the signals of the VDD1 are lower than the threshold value of the determination circuit for the VDD2. In a case where the VDD1 is much lower than the VDD2, the high level of the signals for the VDD1 is lower than the threshold value of the circuit for the VDD2, and the signals for the VDD1 are then not shifted to the high level of the signals for the VDD2.

For example, in a case where VDD2=0.8 V and the VDD1 is lowered to 0.3 V, the level shifter 21 stops operating and does not output the signals for the VDD2 at the high level.

As illustrated in FIG. 6B, in a case where the threshold value Vth is of the transistor of the first domain 1 whose operation rate is slow, the VDD1 is increased to a certain degree in order to make the delay smaller than the demanded operating frequency line. Thus, the above problem does not occur. However, when the threshold value Vth of the transistor of the first domain 1 is largely offset to the fast side, the delay is smaller than the demanded operating frequency line even when the VDD1 is largely lowered. However, the difference between the VDD1 and the VDD2 becomes large in this state, and the level shifters stop operating. In other words, in a case of the semiconductor device that has the level shifter, it is insufficient that the power supply voltage is controlled only in accordance with the delay, and it is in addition desired to control the power supply voltage so that the level shifter does not malfunction.

It is desired that the difference between the VDD1 and the VDD2 does not become equal to or greater than a prescribed value so that the level shifters do not malfunction. In the above case, because the VDD2 is fixed, it is desired to set the VDD1 to a prescribed level shifter minimum operating voltage VDDmin or higher.

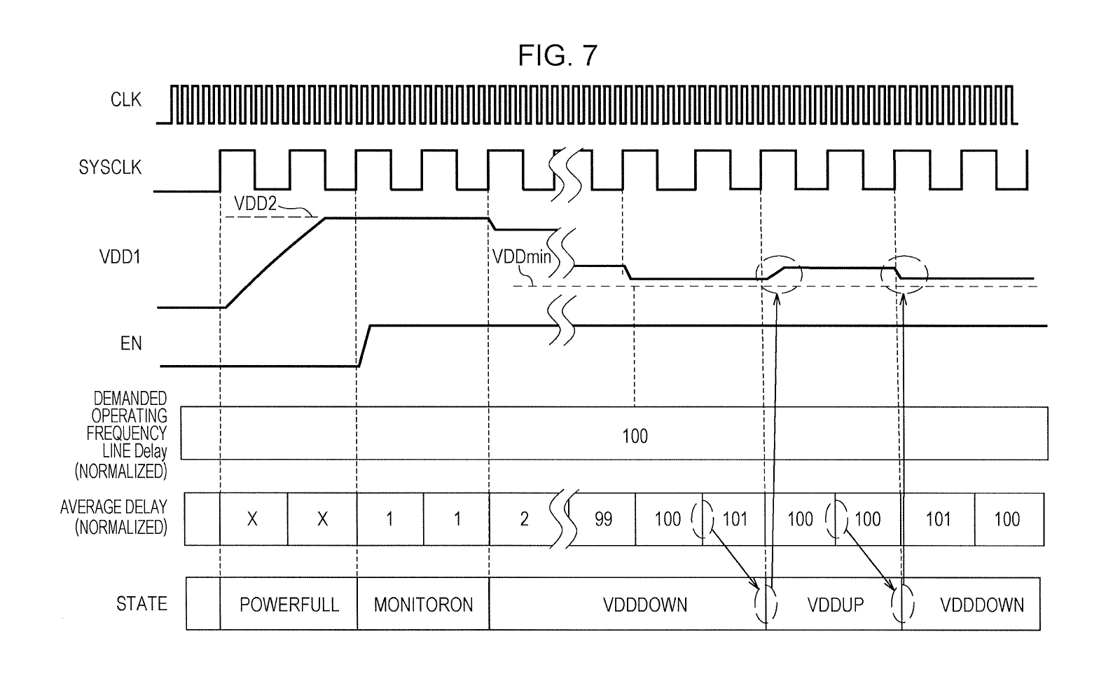

FIG. 7 is a timing diagram in a case where an operation rate of a transistor is fast in the semiconductor device to which the multiple power supply AVS technology described in FIG. 6A is applied and the semiconductor device operates without restricting the VDD1 to the VDDmin or higher.

In FIG. 7, it is assumed that the delay of the limit line of the demanded operating frequency is “100”. When the VDD1 is the maximum value (=VDD2), the delay is small, and “1” is output, for example.

When the state transits to “VDDDOWN” and the VDD1 is sequentially lowered, the VDD1 becomes lower than the VDDmin before the delay exceeds “100”. The VDD1 is controlled such that the delay becomes around “100”, then the VDD1 continuously stays lower than the VDDmin, and the level shifters do not operate.

The delay monitor circuit 5 of the first domain 1 may not in advance detect that the VDD1 becomes lower than the VDDmin and the level shifters then stop operating (malfunction). Thus, the PMU 7 may not control the VDD1 not to become lower than the VDDmin. This may result in malfunction.

A semiconductor device that performs multiple power supply AVS management of embodiments described below controls the power supply voltage so that malfunction does not occur and reduces energy consumption.

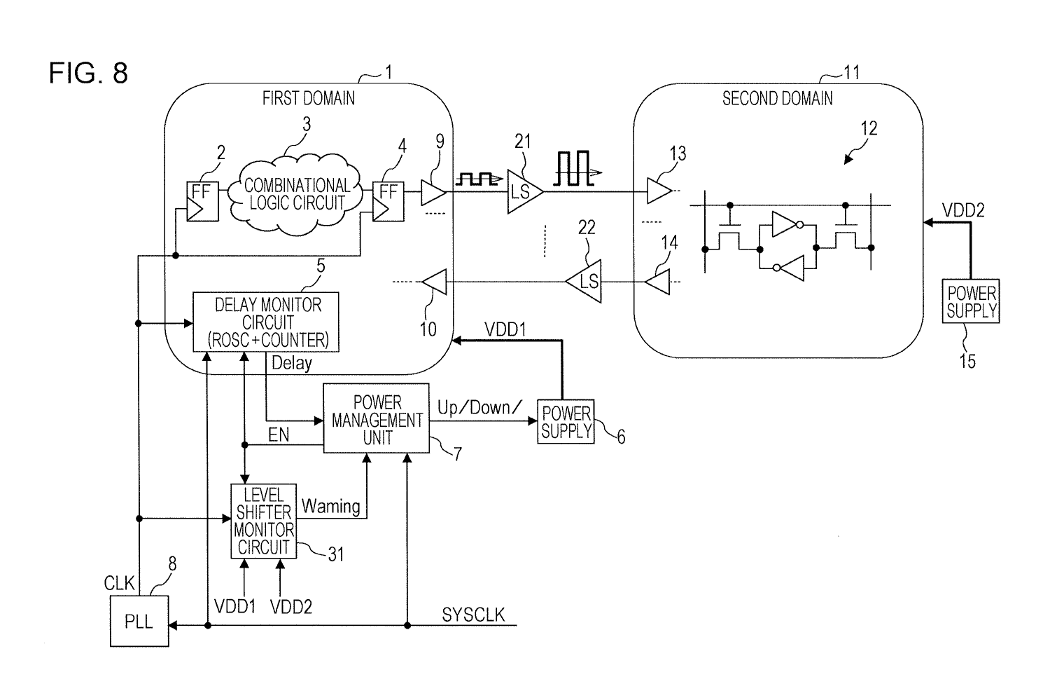

FIG. 8 illustrates a circuit configuration of a semiconductor device of a first embodiment.

The semiconductor device of the first embodiment has a plurality of circuit blocks and has a plurality of power supplies that supply power supply voltages to the plurality of respective circuit blocks. A multiple power supply AVS technology is applied to the semiconductor device.

The semiconductor device of the first embodiment has the first circuit block 1, the power supply 6, the PMU 7, the PLL 8, the second circuit block 11, the power supply 15, the level shifters 21 and 22, and a level shifter monitor circuit 31. The power supply 6, the PMU 7, and the PLL 8 are for the first circuit block (first domain) 1. The power supply 15 is for the second circuit block (second domain) 11.

The first domain 1 has the FF 2, the combinational logic circuit 3, the FF 4, the delay monitor circuit 5, the output buffer 9, and the input buffer 10. The second domain 11 has a large number of the SRAM elements 12, the peripheral circuits thereof, the input buffer 13, and the output buffer 14.

In other words, the semiconductor device of the first embodiment is different from the above-described semiconductor device illustrated in FIG. 3 in a point that the level shifter monitor circuit 31 is provided and the PMU 7 uses a warning signal Warning that is output by the level shifter monitor circuit 31 for control, and the other features are the same. Thus, a description will be made about the level shifter monitor circuit 31 and the PMU 7, and a description about the other circuit elements will not be made. The level shifter monitor circuit 31 receives the VDD1 and the VDD2 similarly to the level shifters 21 and 22. The level shifter monitor circuit 31 outputs the warning signal Warning immediately before the VDD1 lowers exceeding the level shifter minimum operating voltage (VDDmin) at which the level shifters 21 and 22 stop operating. Further, an operation state (on or off) of the level shifter monitor circuit 31 is controlled by the PMU 7.

A description will first be made about generation of the warning signal Warning by the level shifter monitor circuit 31 and control by using the warning signal Warning by the PMU 7.

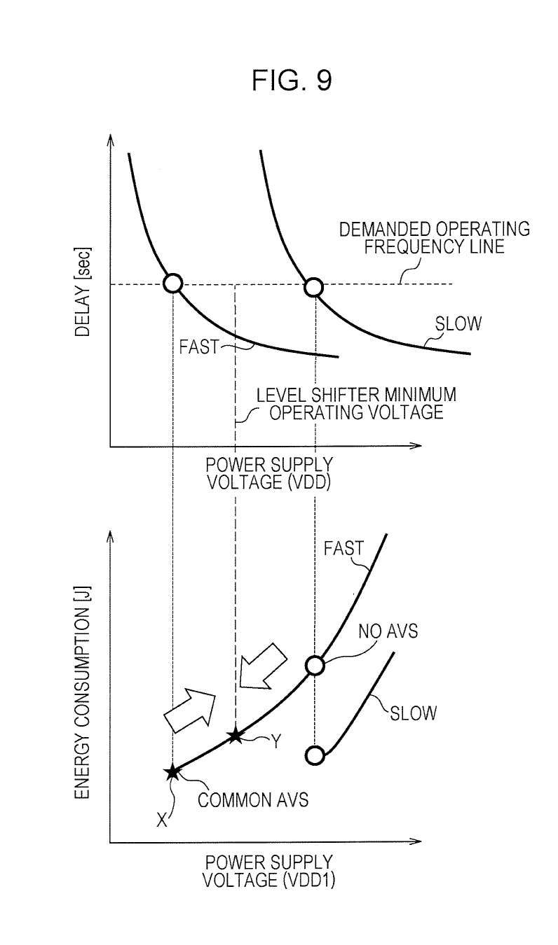

FIG. 9 explains control in the AVS technology that is executed in the first embodiment. An upper side of FIG. 9 illustrates a change in a delay of the circuit (transistor) with respect to a change in the power supply voltage VDD and illustrates cases where operation rates of the transistor are slow and fast. A lower side of FIG. 9 illustrates an example of a change in circuit energy consumption with respect to the change in the power supply voltage VDD and illustrates the cases where the operation rates of the transistor are slow and fast. The upper side of FIG. 9 is the same as FIG. 6B, a range in which the delay is smaller than the demanded operating frequency line and the VDD1 is higher than the level shifter minimum operating voltage is an operating range, and control is performed so that the VDD1 falls within the range. Malfunction of the level shifters occurs when the VDD1 becomes lower than the level shifter minimum operating voltage. Because it is not preferable that the level shifters malfunction during the operation, a voltage that is slightly higher than the level shifter minimum operating voltage is set as a first margin voltage. The level shifter monitor circuit 31 malfunctions and produces the warning signal Warning when the VDD1 becomes lower than the first margin voltage.

In the above-described AVS technology of FIG. 6A, as illustrated in the lower side of FIG. 9, the VDD1 is lowered to a voltage indicated by X in a case where the operation rate of the transistor is fast because the delay is smaller than the demanded operating frequency line even when the VDD1 is largely lowered. However, the level shifters stop operating in this state. By contrast, in the first embodiment, when the level shifter monitor circuit 31 produces the warning signal Warning in a case where the VDD1 is lowered, that is, when the VDD1 becomes lower than the first margin voltage (the point indicated by Y in FIG. 9), control is performed such that the VDD1 is conversely increased by a unit amount. Accordingly, the VDD1 does not become lower than the level shifter minimum operating voltage, and the level shifters 21 and 22 normally operate.

Summarizing AVS management in the first embodiment, the level shifter monitor circuit 31 produces the warning signal Warning before the VDD1 lowers to the level shifter minimum operating voltage (VDDmin).

Further, the PMU 7 outputs an instruction to make the power supply 6 increase the VDD1 when the PMU 7 receives the warning signal Warning.

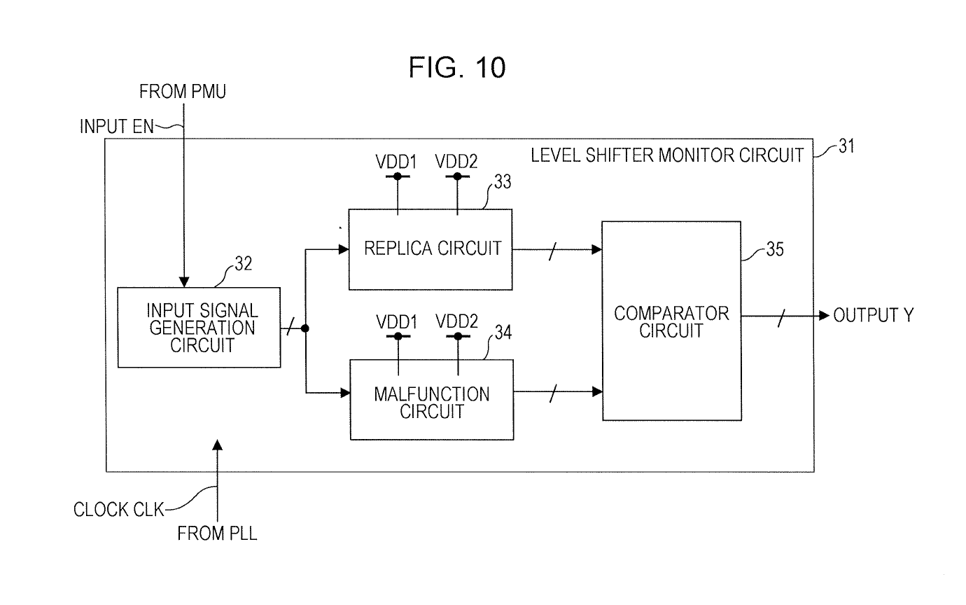

FIG. 10 is a block diagram that illustrates a configuration example of the level shifter monitor circuit 31.

The level shifter monitor circuit 31 has an input signal generation circuit 32, a replica circuit 33, a malfunction circuit 34, and a comparator circuit 35. The input signal generation circuit 32 produces a signal for the VDD1 that alternately changes between zero and one when the control signal EN from the PMU 7 is at a high level. The replica circuit 33 is a circuit that has the same circuit configuration and properties as the level shifter 21, is supplied with the VDD1 and the VDD2, and shifts the level of the signals for the VDD1 that are input from the input signal generation circuit 32 to the level of the signals for the VDD2. The malfunction circuit 34 has the same circuit configuration as the level shifter 21, is supplied with the VDD1 and the VDD2, and shifts the level of the signals for the VDD1 that are input from the input signal generation circuit 32 to the level of the signals for the VDD2, but malfunctions when the VDD1 becomes lower than the first margin voltage. In other words, the malfunction circuit 34 malfunctions at a higher voltage than a voltage at which the replica circuit 33 malfunctions. The comparator circuit 35 determines whether or not a signal for the VDD2 that is output by the replica circuit 33 and alternately changes between zero and one agrees with a signal for the VDD2 that is output by the malfunction circuit 34 and alternately changes between zero and one. Both of the replica circuit 33 and the malfunction circuit 34 are the level shifters, to which the same signal is input from the input signal generation circuit 32. Thus, the comparator circuit 35 detects agreement in a case where both of the replica circuit 33 and the malfunction circuit 34 normally operate. If an output Y of the comparator circuit 35 indicates disagreement, a determination is made that one of the replica circuit 33 and the malfunction circuit 34 malfunctions and specifically the malfunction circuit 34 that malfunctions at the higher VDD1 malfunctions.

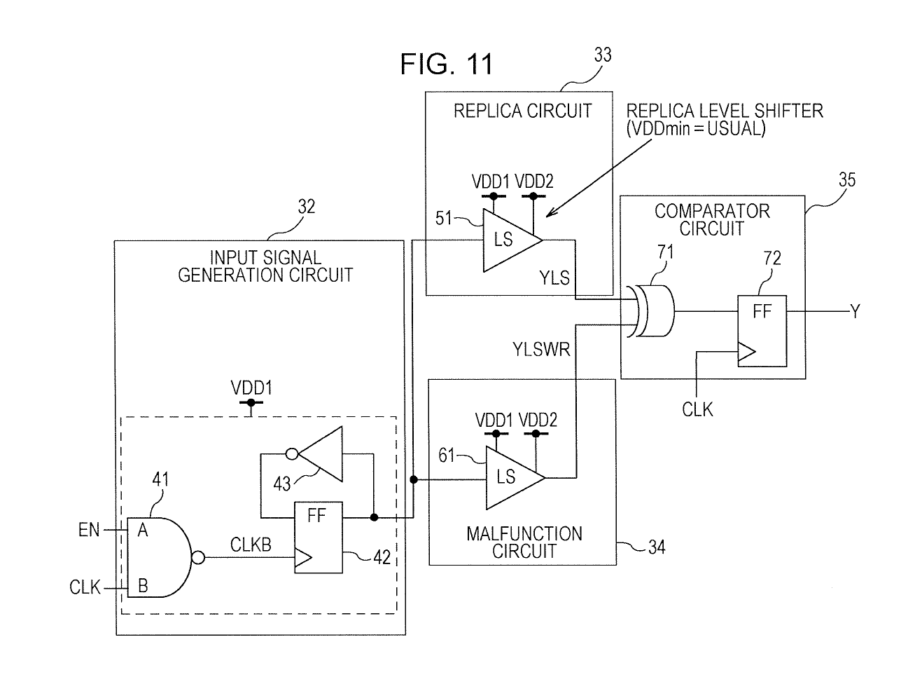

FIG. 11 is a circuit diagram that illustrates a more specific configuration example of the level shifter monitor circuit 31.

The input signal generation circuit 32 has a NAND gate 41, an FF 42, and an inverter 43. The NAND gate 41 allows the internal clock CLK from the PLL 8 to pass through and outputs that as a signal for the VDD1 when the control signal EN from the PMU 7 is at a high level, blocks the internal clock CLK when the EN is at a low level, and outputs a signal that is fixed at a high level. The FF 42 and the inverter 43 forms a ½ frequency divider circuit and outputs a signal in which the frequency of the internal clock CLK is divided into a half when the EN is at the high level.

The replica circuit 33 has a level shifter 51 that has the same circuit configuration and properties as the level shifter 21, shifts the level of an input signal to the level of the signal for the VDD2, and outputs the input signal as YLS.

The malfunction circuit 34 has a level shifter 61 that has the same circuit configuration and properties as the level shifter 21, shifts the level of an input signal to the level of the signal for the VDD2, and outputs the input signal as YLSWR, but malfunctions when the VDD1 becomes lower than the first margin voltage that is higher than the VDDmin. In other words, the level shifter 61 malfunctions prior to the level shifter 51 in a case where the VDD1 is lowered.

The comparator circuit 35 has an exclusive disjunction gate (EXOR) 71 that detects agreement between YLS and YLSWR and an FF 72 that takes in and retains a result of the determination synchronously with the CLK and outputs the result as Y.

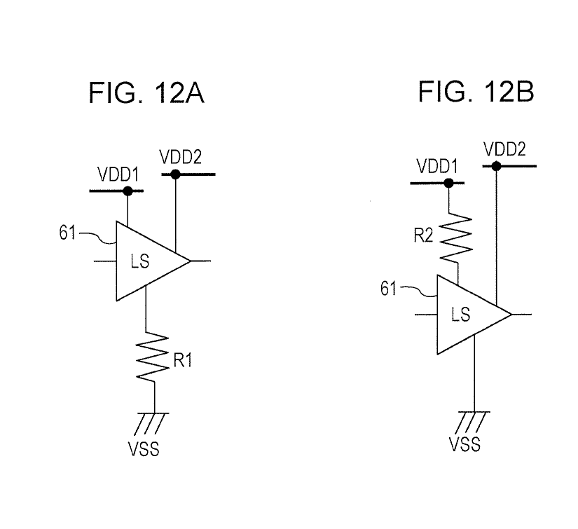

FIGS. 12A and 12B illustrate a configuration example of the malfunction circuit 34.

In FIG. 12A, the level shifter 61 in the same configuration as the level shifter 21 is directly connected to the VDD1 and the VDD2 similarly to the level shifter 21 but is connected to a GND via a resistor R1. The power supply voltage supplied to the level shifter 61 is thereby effectively lowered, and the level shifter 61 malfunctions when the VDD1 becomes lower than the first margin voltage that is higher than the VDDmin.

In FIG. 12B, the level shifter 61 in the same configuration as the level shifter 21 is directly connected to the VDD2 and the GND similarly to the level shifter 21 but is connected to the VDD1 via a resistor R2. The power supply voltage VDD1 actually supplied to the level shifter 61 is thereby lowered, and the level shifter 61 malfunctions when the VDD1 becomes lower than the first margin voltage that is higher than the VDDmin.

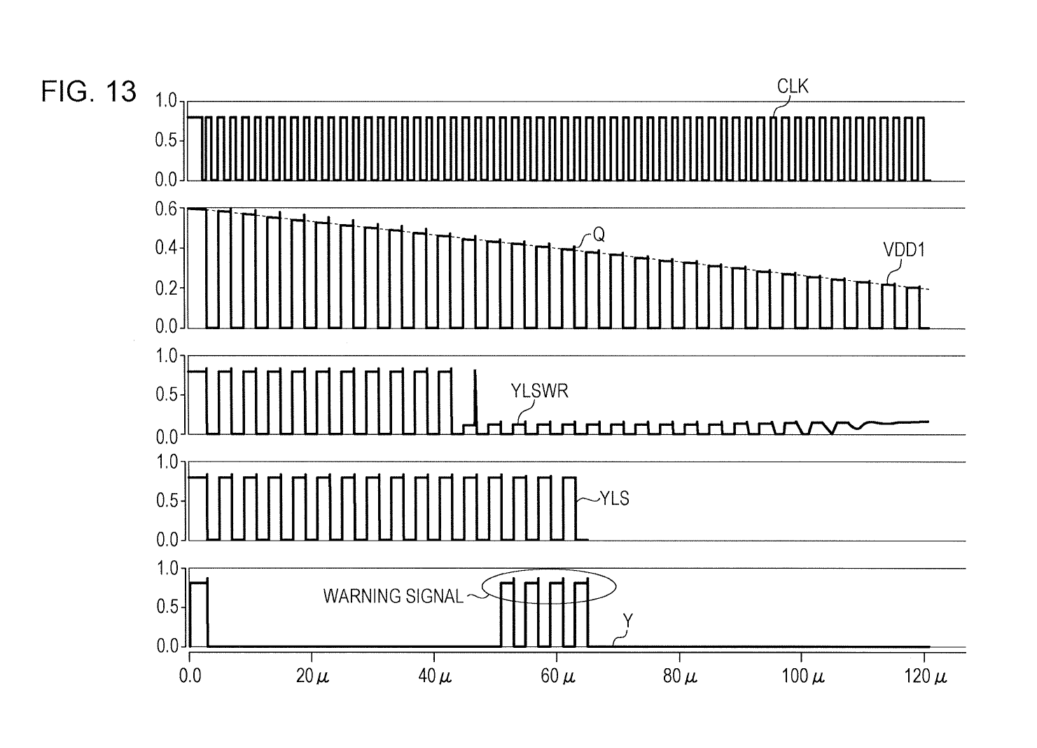

FIG. 13 illustrates a result of an operation simulation of the level shifter monitor circuit 31 of FIG. 11. When the EN is set to a high level and the VDD1 is a high voltage, the output YLS of the replica circuit 33 and the output YLSWR of the malfunction circuit 34 alternately change between zero and one. Thus, the output Y of the comparator circuit 35 is at a low level (zero). When the VDD1 is gradually lowered, the output YLS of the replica circuit 33 still alternately changes between zero and one, but the output YLSWR of the malfunction circuit 34 stops changing to a high level. Thus, the output Y of the comparator circuit 35 alternately changes between zero and one, and the warning signal Warning is produced.

As described above, the first margin voltage at which the malfunction circuit 34 normally operates is higher than the minimum operating voltage VDDmin at which the replica circuit 33 normally operates. Thus, the level shifter monitor circuit 31 outputs the warning signal Warning (with a margin provided) before the replica circuit 33 does not normally operate.

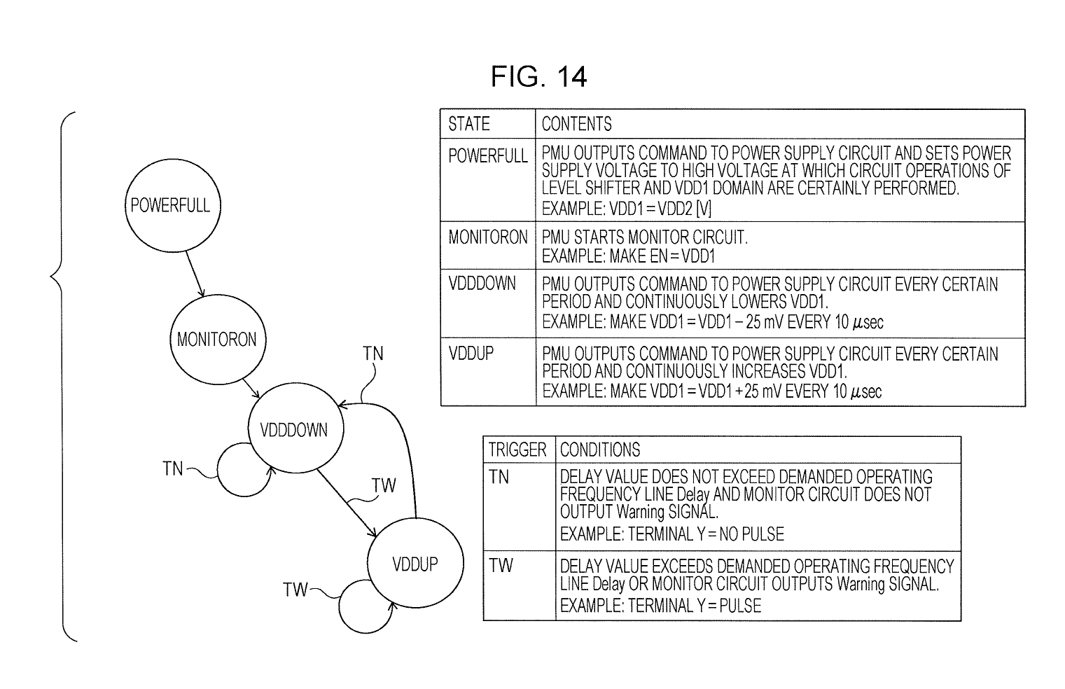

FIG. 14 is an operation state transition diagram that illustrates an operation sequence of the semiconductor device to which the multiple power supply AVS technology of the first embodiment is applied. This transition diagram relates only to the first domain 1.

As illustrated in FIG. 4, states of “POWERFULL”, “MONITORON”, “VDDDOWN”, and “VDDUP” are present, and the operation sequence transits among those.

In the “POWERFULL” state, the voltage of the VDD1 is set to a high voltage that certainly secures an operation of an internal circuit of the first domain 1 that is connected to the level shifters 21 and 22 and the VDD1. For example, setting is made such that VDD1=1.2 V. Accordingly, power management may be performed without malfunction of the circuit.

In the “MONITORON” state, the PMU 7 sets the EN at a high level (VDD1) and starts the delay monitor circuit 5 and the level shifter monitor circuit 31.

In the “VDDDOWN” state, the PMU 7 repeatedly outputs a command to make the power supply 6 lower the VDD1 by a prescribed amount every certain period. For example, the PMU 7 outputs the command to make VDD1=VDD1−25 mV every 10μ seconds. Here, the “VDDDOWN” state is maintained in a case of a trigger TN, and the state transits to the “VDDUP” state in a case of a trigger TW.

In the “VDDUP” state, the PMU 7 repeatedly outputs a command to make the power supply 6 increase the VDD1 by a prescribed amount every certain period. For example, the PMU 7 outputs the command to make VDD1=VDD1+25 mV every 10μ seconds. Here, the state transits to the “VDDDOWN” state in a case of the trigger TN, and the “VDDUP” state is maintained in a case of the trigger TIN.

The trigger TN is output in a case where an output delay of the delay monitor circuit 5 does not exceed the demanded operating frequency line and the level shifter monitor circuit 31 does not output the warning signal Warning.

The trigger TW is output in a case where the output delay of the delay monitor circuit 5 exceeds the demanded operating frequency line or the level shifter monitor circuit 31 outputs the warning signal Warning.

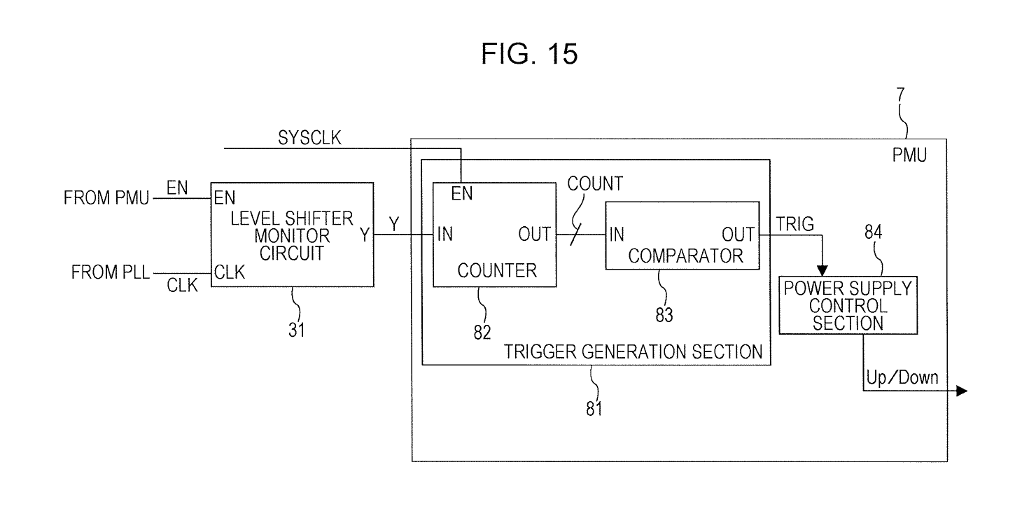

FIG. 15 is a block diagram that illustrates a circuit configuration of the power management unit (PMU) 7.

The PMU 7 has a trigger generation section 81 and a power supply control section 84. The trigger generation section 81 has a counter 82 and a comparator 83. The counter 82 becomes the operation state while the system clock SYSCLK is at a high level and counts the warning signal Warning illustrated in FIG. 13 that is output by the level shifter monitor circuit 31. The comparator 83 outputs an internal trigger TRIG in a case where a count value of the counter 82 is large compared to a prescribed value. Accordingly, an influence of noise on the output Y of the level shifter monitor circuit 31 is canceled, and a determination of the warning signal Warning is certainly made.

A power supply control section 84 generates and outputs a control signal UP or Down of the power supply 6 that corresponds to the trigger TN or TW in FIG. 14 in accordance with the internal trigger TRIG.

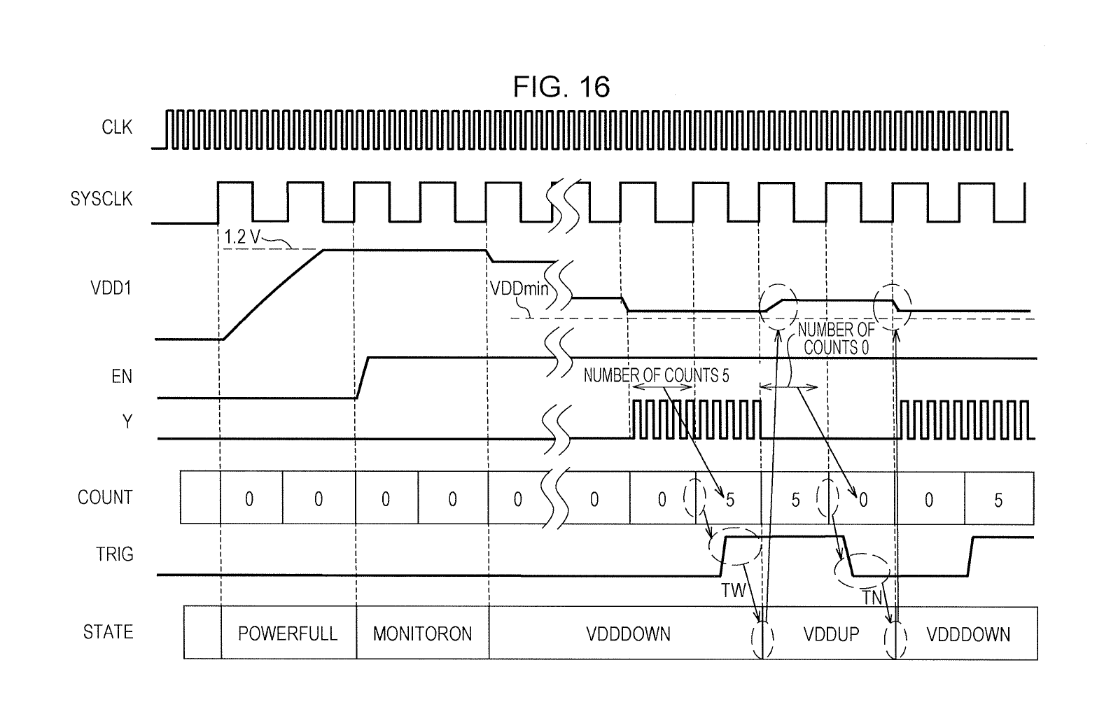

FIG. 16 is a timing diagram that illustrates an operation of the power management unit (PMU) 7.

The VDD1 increases in the “POWERFULL” state and increases to a maximum value of 1.2 V, for example. During this, because the level shifter monitor circuit 31 is not in the operation state, the output Y of the level shifter monitor circuit 31 is at a low level, the count value that is output by the counter 82 is zero, and the TRIG that is output by the comparator 83 is at a low level.

In the “MONITORON” state, the PMU 7 turns the signal EN on (high), which makes the delay monitor circuit 5 and the level shifter monitor circuit 31 become the operation state. In response to this, the delay monitor circuit 5 measures and outputs the delay, and the level shifter monitor circuit 31 outputs an agreement detection result as the output Y. Because the VDD1 is 1.2 V and sufficiently high, the output Y of the level shifter monitor circuit 31 is at a low level, the count value that is output by the counter 82 is zero, and the TRIG that is output by the comparator 83 is also at a low level.

Because the delay is lower than the limit line and the output Y of the level shifter monitor circuit 31 is at a low level, the state transits to “VDDDOWN”, and the VDD1 is lowered by a unit amount. Repeating this leads to a decrease in the VDD1. Although the delay that is output by the delay monitor circuit 5 increases as described above, a description will be made here on the assumption that the VDD1 becomes lower than the first margin voltage before the delay exceeds the demanded operating frequency line. When the VDD1 becomes lower than the first margin voltage, the malfunction circuit 34 of the level shifter monitor circuit 31 malfunctions, and the output Y of the level shifter monitor circuit 31 repeats an alternation between zero and one. In response to this, because the count value that is output by the counter 82 increases (becomes five here) and exceeds a reference value (for example, one), the TRIG becomes a high level, and the power supply control section 84 outputs a command Up that instructs to increase the VDD1. In response to this, the state transits to “VDDUP”, and the VDD1 is increased by the unit amount. Because the VDD1 increases, the output Y of the level shifter monitor circuit 31 is fixed to zero, the count value becomes zero, and the state thus transits to “VDDDOWN”. Such an operation is repeated subsequently. Accordingly, control is made such that the VDD1 stays around the level shifter minimum operating voltage (in a range between slightly higher and lower voltages than the first margin voltage) without becoming lower than the level shifter minimum operating voltage.

The semiconductor device of the first embodiment is described in the above. In the first embodiment, the VDD1 is controlled based on both of the delay of the first domain 1 and the determination result of whether or not the level shifters are operable. Particularly, because the internal circuit of the first domain 1 normally operates even when the operating frequency becomes low (for example, several hundred kHz or lower) and the delay is large, the VDD1 may be controlled to become a low voltage. In such a case, the level shifters do not operate, and the semiconductor device does not normally operate. In the semiconductor device of the first embodiment, the VDD1 does not lower to a voltage at which the level shifter does not operate. As described above, the first embodiment provides a multiple power supply AVS power management technology with high reliability.

In the semiconductor device of the first embodiment, as illustrated in FIG. 16, the state frequently transits between “VDDDOWN” and “VDDUP”. Thus, a ripple (small voltage fluctuation) arises on the VDD1 that is supplied to the first domain 1. This is not preferable in terms of a stable operation of the first domain 1.

In a second embodiment that will next be described, a frequent fluctuation in the VDD1 is reduced.

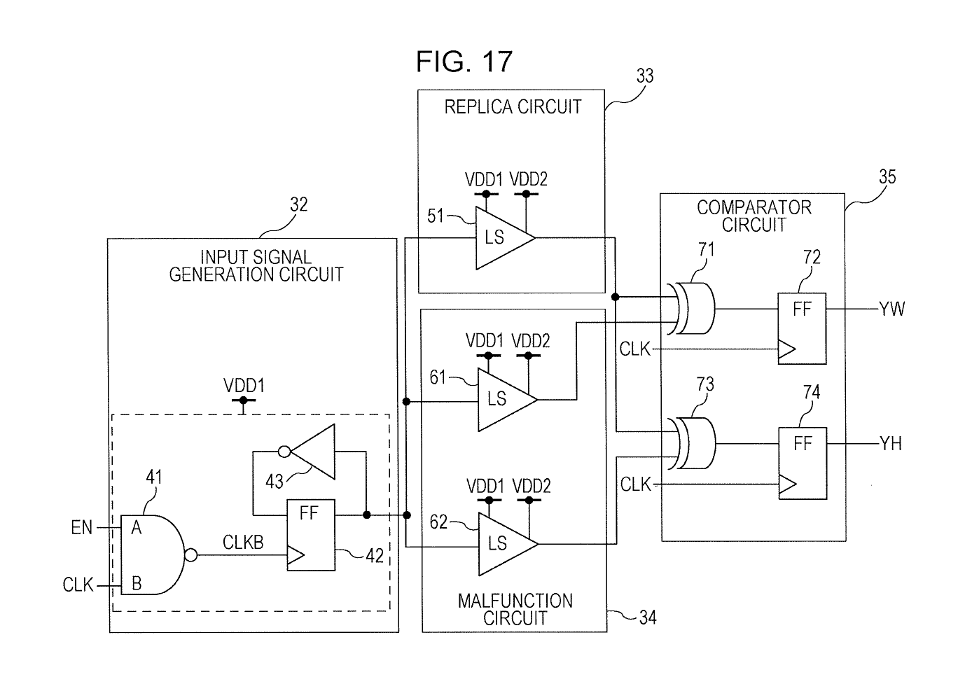

FIG. 17 illustrates a circuit configuration of the level shifter monitor circuit 31 of the semiconductor device of a second embodiment. In the semiconductor device of the second embodiment is different from the first embodiment in a point that the level shifter monitor circuit 31 is different and the PMU 7 performs control in consideration of other signals that are output by the level shifter monitor circuit 31, but the other features are the same.

In the level shifter monitor circuit 31 of the second embodiment, the malfunction circuit 34 has a level shifter 62 in addition to the level shifter 61. The level shifter 62 shifts the level of an input signal to the level of the signal for the VDD2 and outputs the input signal but malfunctions when the VDD1 becomes lower than a second margin voltage that is higher than the first margin voltage. In other words, the level shifter 62 malfunctions prior to the level shifter 61 in a case where the VDD1 is lowered.

In addition, in the level shifter monitor circuit 31 of the second embodiment, the comparator circuit 35 has an EXOR 73 and an FF 74 in addition to the EXOR 71 and the FF 72. The EXOR 73 detects agreement between YLS that is output by the level shifter 51 and an output of the level shifter 62. The FF 74 takes in and retains a comparison result by the EXOR 73 synchronously with the CLK and outputs the comparison result as a hold signal YH. The FF 72 takes in and retains a comparison result by the EXOR 71 synchronously with the CLK and outputs the comparison result as a warning signal YW.

The level shifter 62 of FIG. 17 that malfunctions when the VDD1 becomes lower than the second margin voltage that is higher than the first margin voltage is implemented by setting resistance values of the resistor R1 in FIG. 12A and the resistor R2 in FIG. 12B to greater values, for example.

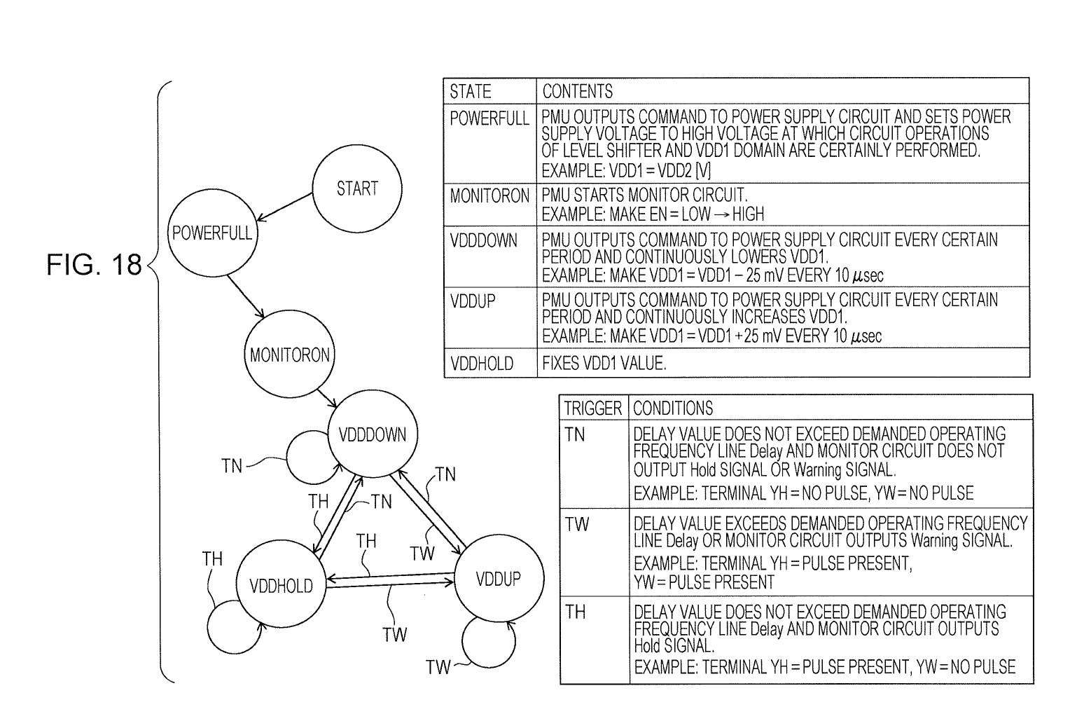

FIG. 18 is an operation state transition diagram that illustrates an operation sequence of the semiconductor device to which the multiple power supply AVS technology of the second embodiment is applied. This transition diagram relates only to the first domain 1.

As it is clear from a comparison with FIG. 14, the operation state transition diagram of the second embodiment is different from the first embodiment in a point that a “VDDHOLD” state and a trigger TH are added, but the other features are the same. Accordingly, the difference will be described.

A value of the VDD1 is maintained in the “VDDHOLD” state. The trigger TH is output in a case where the output delay of the delay monitor circuit 5 does not exceed the demanded operating frequency line and the level shifter monitor circuit 31 outputs the hold signal YH. Specifically, the trigger TH is output in a case where a pulse is not output in the output YW of the level shifter monitor circuit 31 but the pulse is output in the output YH.

In “VDDHOLD”, the state is maintained when the trigger TH is output. The state transits to “VDDDOWN” when the trigger TN is output, and the state transits to “VDDUP” when the trigger TW is output.

In “VDDDOWN”, the state is maintained when the trigger TN is output. The state transits to “VDDHOLD” when the trigger TH is output, and the state transits to “VDDUP” when the trigger TW is output.

In “VDDUP”, the state is maintained when the trigger TW is output. The state transits to “VDDHOLD” when the trigger TH is output, and the state transits to “VDDDOWN” when the trigger TN is output.

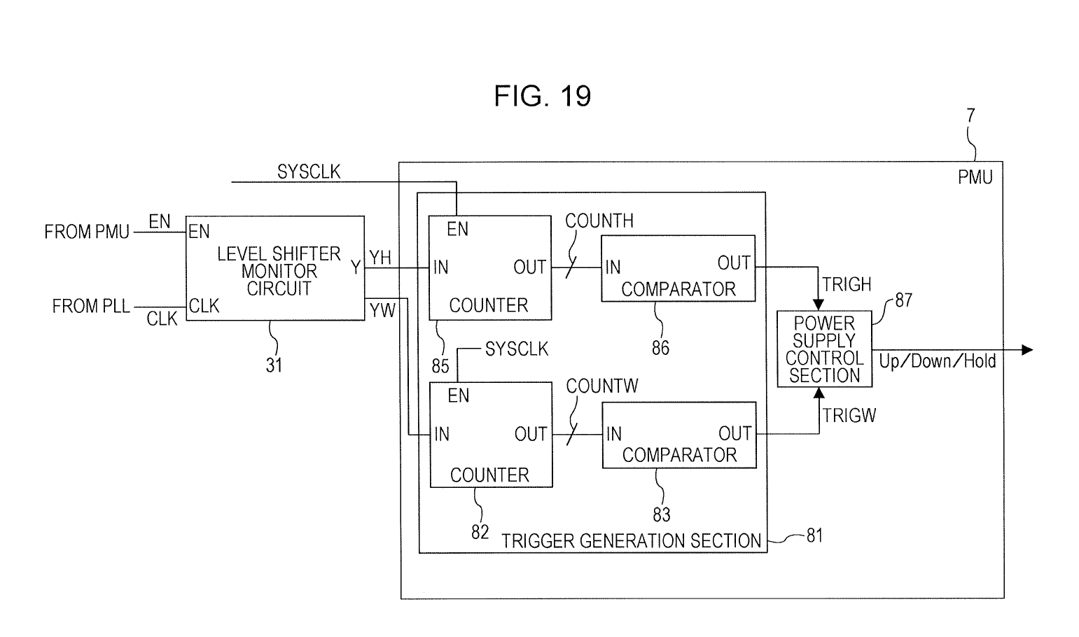

FIG. 19 is a block diagram that illustrates a circuit configuration of the power management unit (PMU) 7 of the semiconductor device of the second embodiment.

The PMU 7 of the second embodiment is different from the first embodiment in a point that the trigger generation section 81 further has a counter 85 and a comparator 86, and a power supply control section 87 generates control signals Up, Down, and Hold of the power supply 6 from outputs of the comparators 83 and 86. The other features are the same as the first embodiment.

The counter 85 is different only in a point that the output YH of the FF 74 is input, and the other features are the same as those of the counter 82. The comparator 86 is the same as the comparator 83. An output of the comparator 83 is referred to as TRIGW, and an output of the comparator 86 is referred to as TRIGH. Thus, when the pulse occurs in the output YH of the FF 74, the TRIGH becomes a high level.

The power supply control section 87 generates the control signals Up, Down, and Hold of the power supply 6 while following the sequence illustrated in FIG. 18 based on the TRIGW and TRIGH.

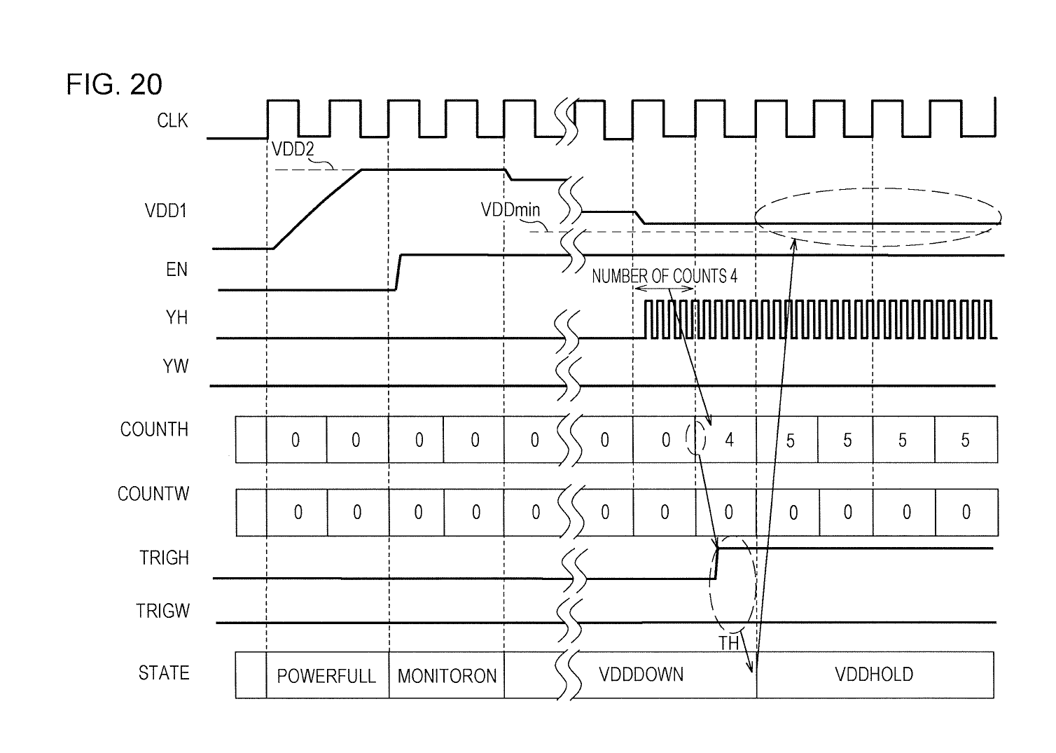

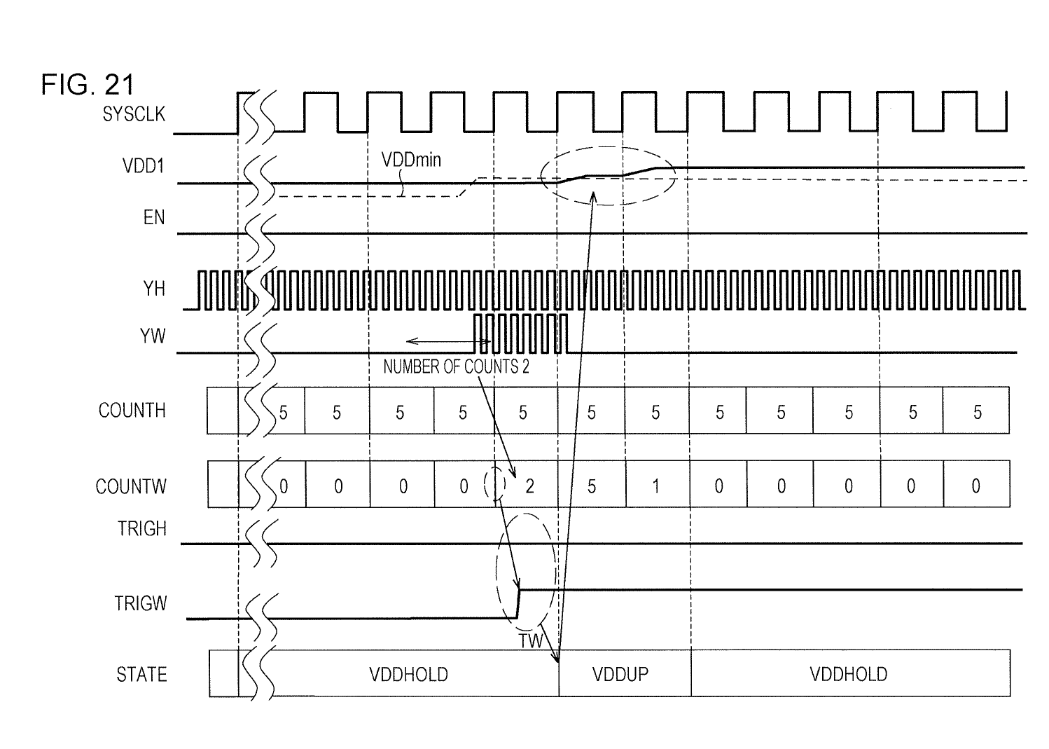

FIGS. 20 and 21 are timing diagrams that illustrate the operation of the power management unit (PMU) 7 of the second embodiment.

The sequence from the start to the transition to “VDDDOWN” is the same as the first embodiment in FIG. 16, and a description thereof will not be made.

The VDD1 is lowered by the unit amount in “VDDDOWN”. Repeating this leads to a decrease in the VDD1. Although the delay that is output by the delay monitor circuit 5 increases as described above, a description will be made here on the assumption that the VDD1 exceeds the second margin voltage and the first margin voltage before the delay exceeds the demanded operating frequency line. In response to this, the level shifter 62 of the malfunction circuit 34 malfunctions, and the output YH of the level shifter monitor circuit 31 repeats an alternation between zero and one. In response to this, because a count value COUNTH that is output by the counter 85 increases (becomes four here) and exceeds a reference value (for example, three), the TRIGH becomes a high level. During this, the level shifter 61 of the malfunction circuit 34 normally operates, the output YW of the level shifter monitor circuit 31 is maintained at a low level, a count value COUNTW of the counter 82 is zero, and the TRIGW is maintained at a low level. Thus, the power supply control section 84 outputs a command HOLD that instructs to maintain the VDD1. In response to this, the state transits to “VDDHOLD”. Because a voltage value of the VDD1 is thereafter maintained, the output YH repeats an alternation between zero and one, and the TRIGH thus maintains a high level. The output YW is maintained at a low level, and the TRIGW thus maintains a low level. Accordingly, the state is maintained in “VDDHOLD”, the power supply control section 84 outputs the command HOLD that instructs to maintain the VDD1, and the VDD1 thus does not change. As described above, the VDD1 is stable, and the ripple does not arise on the VDD1.

As illustrated in FIG. 21, it is assumed that the minimum operating voltage VDDmin increases for some reason (for example, a temperature increase) and the VDD1 becomes lower than the VDDmin. In such a case, the level shifter 61 of the malfunction circuit 34 malfunctions, and the output YW of the level shifter monitor circuit 31 repeats an alternation between zero and one. In response to this, because the count value COUNTW that is output by the counter 82 increases (becomes two here) and exceeds a reference value (for example, one), the TRIGW becomes a high level.

During this, the level shifter 62 of the malfunction circuit 34 still malfunctions, the output YH of the level shifter monitor circuit 31 repeats an alternation between zero and one, the count value COUNTH is a reference value (five here) or greater, and the TRIGH becomes a high level. Thus, the power supply control section 84 outputs the command Up that instructs to increase the VDD1. In response to this, the state transits to “VDDUP”, and the VDD1 is increased by the unit amount. Because the VDD1 increases, the output YW of the level shifter monitor circuit 31 becomes a low level, the count value becomes zero, and the state thus transits to “VDDHOLD”. Such an operation is repeated subsequently. Accordingly, the VDD1 is stably maintained between the first margin voltage and the second margin voltage and is controlled to return to a range between the first margin voltage and the second margin voltage in cases where the VDD1 becomes lower than the first margin voltage and higher than the second margin voltage.

The first and second embodiments are described in the above. However, it is matter of course that various modifications are possible. For example, the second circuit block (second domain) 11 may be an element other than the SRAM. In the first and second embodiments, the power supply voltage VDD2 that is supplied to the second circuit block (second domain) 11 is fixed. However, the VDD2 may be changed in accordance with a load.

In addition, the malfunction circuit may be any kind of circuit as long as the circuit malfunctions at a voltage higher than the minimum operating voltage VDDmin and may easily detect malfunction.

The embodiments have been described in the foregoing. However, all the examples and conditions described herein are described for the purpose of aiding understanding the concept of the disclosure which is applied to disclosures and technologies. The particularly described examples and conditions are not intended to limit the scope of the present disclosure, and the configurations of such examples of this specification do not represent advantages or disadvantages of the disclosure. The embodiments of the disclosure have been described in detail. However, it is understood that changes, substitutions, and modifications may be made without departing from the gist and the scope of the disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A semiconductor device comprising:
a first power supply that supplies a first power supply voltage;
a second power supply that supplies a second power supply voltage that is equal to or higher than the first power supply voltage;
a first circuit block that is supplied with the first power supply voltage from the first power supply to operate;
a second circuit block that is supplied with the second power supply voltage from the second power supply to operate;
level shifters that are supplied with the first power supply voltage and the second power supply voltage from the first power supply and the second power supply to operate and shift a signal for the first power supply voltage to a signal for the second power supply voltage and shift the signal for the second power supply voltage to the signal for the first power supply voltage;
a power management unit that controls the first power supply to change the first power supply voltage; and
a level shifter monitor circuit that generates a first malfunction signal at a first margin voltage that is higher than the first power supply voltage at which the level shifter does not normally operate in a case where the first power supply voltage lowers,
wherein the power management unit controls the first power supply so that the first power supply voltage does not become lower than the first margin voltage.

2. The semiconductor device according to claim 1, wherein the level shifter monitor circuit has at least one first malfunction level shifter that malfunctions at the first margin voltage and generates a first malfunction precautionary detection signal in a case where the level shifter normally operates and the first malfunction level shifter does not normally operate.

3. The semiconductor device according to claim 2, wherein the level shifter monitor circuit has at least one second malfunction level shifter that malfunctions at a second margin voltage that is higher than the first margin voltage and generates a second malfunction precautionary detection signal in a case where the second malfunction level shifter does not normally operate.

4. The semiconductor device according to claim 3, wherein the power management unit controls the first power supply to lower the first power supply voltage by a unit amount in a case where the power management unit does not receive the first malfunction precautionary detection signal or the second malfunction precautionary detection signal, to maintain the first power supply voltage in a case where the power management unit does not receive the first malfunction precautionary detection signal and receives the second malfunction precautionary detection signal, and to increase the first power supply voltage by a unit amount in a case where the power management unit receives the first malfunction precautionary detection signal.

5. The semiconductor device according to claim 1, wherein the power management unit sets the first power supply voltage to a voltage at which the first circuit block and the level shifter do not malfunction in a start of an operation.

6. The semiconductor device according to claim 2, wherein the first malfunction level shifter has a same structure as the level shifter and is connected to the first power supply via a resistor of a greater resistance value than the level shifter.

7. The semiconductor device according to claim 3, wherein the second malfunction level shifter has a same structure as the level shifter and is connected to the first power supply via a resistor of a resistance that is higher than a connection resistance of the level shifter to the first power supply and a connection resistance of the first malfunction level shifter to the first power supply.

8. The semiconductor device according to claim 1, further comprising:
an operation monitor circuit that has a delay path in which a delay increases in a case where the first power supply voltage lowers and generates an operation limit signal in a case where the delay of the delay path exceeds a prescribed value,
wherein the power management unit controls the first power supply to increase the first power supply voltage by the unit amount in a case where the operation limit signal is produced in lowering the first power supply voltage by the unit amount.
